(19) United States
(12) Patent Application Publication
(10) Pub. No.: US 2012/0275169 A1
(43) Pub. Date: Nov. 1, 2012

(54) COLLAPSIBLE LAMP SHADE

(75) Inventor: Hsieh Pei-Lin, Taipei (TW)

(73) Assignee: Habitex Corporation, Taipei (TW)

(21) Appl. No.: 13/097,951

(22) Filed: Apr. 29, 2011

(51) Int. Cl. F21V 1/06

(52) U.S. Cl. 362/352

(57) ABSTRACT

A collapsible lamp shade includes a bottom ring and a top ring with frame members connected thereto and extending therebetween. The frame members are connected to the bottom ring and the top ring by respective clips that are part of the bottom and top rings.

### TECHNICAL FIELD

The present invention relates to an improved lamp shade and in particular, to a lamp shade that is collapsible and formed of a number of parts that can easily and quickly be assembled.

### BACKGROUND

There are wide range of different lighting products including desk lamps and floor lamps, as well as track lighting fixtures and the like. Desk lamps have been used for desks, offices and studies so as to provide illumination for reading or other purposes and so that one's eyesight is not weakened by the insufficiency of illumination. Hence, these types of lighting products are useful and needed.

Traditional lamp shades structures are constructed from rigid frames surrounded in fabric. One type of lamp shade is made from an upper ring and a lower ring connected by a rigid fabric or by flexible fabric held with supporting rods. The supporting rods usually accept a compression force and the flexible fabric usually accepts a tensile force. The construction of a lamp shade having supporting rods often requires the rods to be connected to the fabric. The fabric is sometimes sewn around the rod. As a result of the structure being constructed as a unit, the lamp shade requires substantial volume.

It would therefore be advantageous to provide a lamp shade that is collapsible so as to reduce the space needed.

### SUMMARY

In accordance with one embodiment of the present invention, a collapsible lamp shade includes a bottom ring having a first periphery and three pairs of bottom clips affixed to the bottom ring. Each bottom clip has respective legs extending from a central base so as to define a c-shaped receptacle having an opening. The opening of the bottom clip is oriented both upwardly and outwardly and one of the legs of each bottom clip is affixed within the first periphery of the bottom ring at a union of the base and one leg thereof. The other leg of each bottom clip extends inwardly and is free of attachment to the bottom ring. Each pairs of bottom clips are affixed to the bottom ring is substantially uniformly spaced from the other pairs of bottom clips that are affixed to the bottom ring.

The lamp shade further includes a top ring having a second periphery that is smaller than the first periphery and three top clips affixed to the top ring. Each top clip has respective legs extending from a central base so as to define a c-shaped receptacle having an opening. The opening of the top-clip is oriented both downwardly and outwardly. One of the legs of each top clip is affixed within the second periphery of the top ring at a union of the base and one leg thereof. The other leg of each top clip extends inwardly and is free of attachment to the top ring. The top clips are substantially uniformly spaced from one another along the top ring.

The lamp shade also includes a fabric shade attached to the top and bottom rings. Three frame members are provided and each has a lower segment, an upper segment and first and second arms each having a length extending therebetween. The lower segment of each frame member extends between the first and second arms and has at least a portion sized to be seatable in one pair of the bottom clips. Similarly, the upper segment of each frame member extends between the first and second arms and has at least a portion sized to be seatable in one of the top clips.

The length of the first and second arms of each frame member is just sufficient to tautly extend the fabric shade between the bottom and top rings when the lower and upper segments are seated in respective bottom and top clips.

These and other aspects, features and advantages shall be apparent from the accompanying Drawings and description of certain embodiments of the invention.

### BRIEF DESCRIPTION OF THE DRAWINGS

FIG. 1 is a top and side perspective view of a collapsible lamp shade according to one embodiment;

FIG. 2 is a top plan view of the collapsible lamp shade of FIG. 1;

FIG. 3 is a cross-sectional view of the collapsible lamp shade;

FIG. 4 is an enlarged perspective view of one bottom clip that is part of the collapsible lamp shade of FIG. 1;

FIG. 5 is a cross-sectional view of the bottom clip;

FIG. 6 is a cross-sectional view of a top clip that is part of the collapsible lamp shade of FIG. 1;

FIG. 7 is a perspective view of a frame member of the collapsible lamp shade of FIG. 1; and

FIG. 8 is a side elevation view of the frame member of FIG. 7.

### DETAILED DESCRIPTION OF CERTAIN EMBODIMENTS OF THE INVENTION

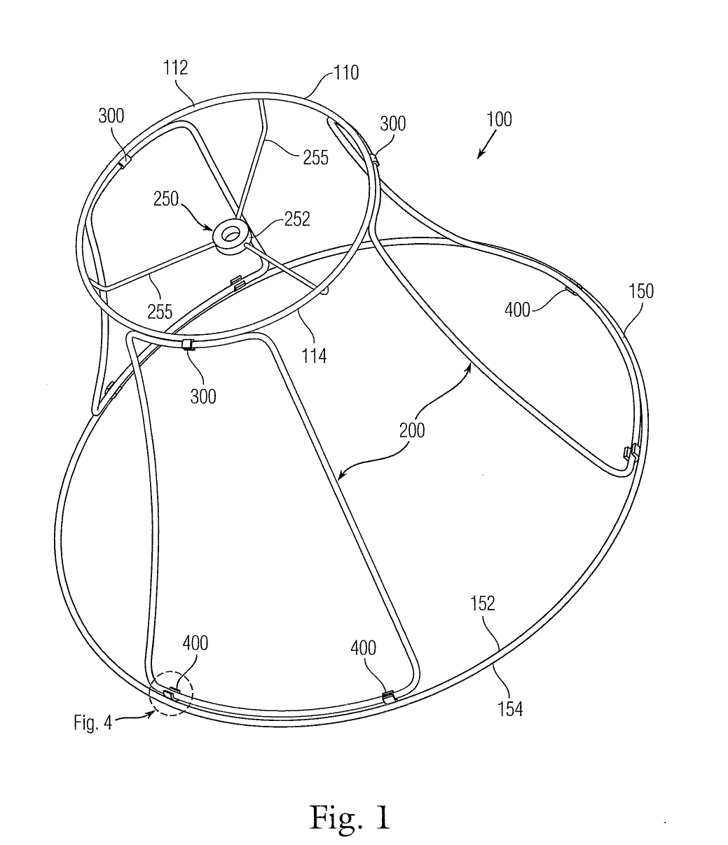

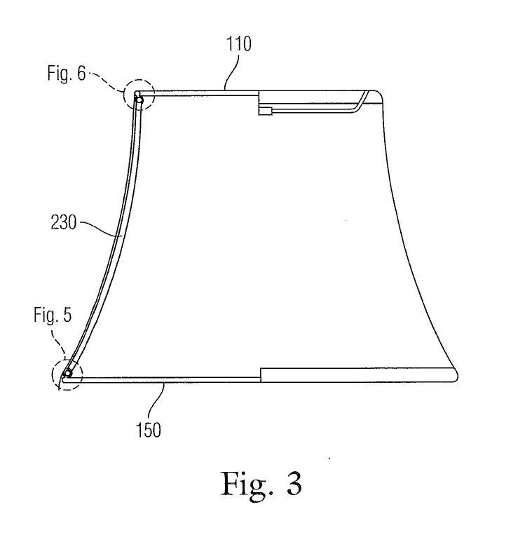

FIGS. 1-8 show a collapsible lamp shade 100 according to one exemplary embodiment of the present invention. The lamp shade 100 is formed of a number of separate parts that are coupled to one another to form the assembled lamp shade 100. More specifically, the lamp shade 100 includes an upper rigid structure 110 and a lower rigid structure 150 and a plurality of frames (frame members) 200 that interconnect the upper and lower rigid structures 110, 150 and support the upper rigid structure 110. The supporting frame members 200 inserted between the upper and lower rigid structures 110, 150 provide rigidity to the lamp shade 100. Shade material, such as fabric, (not shown) is connected between the upper rigid structure 110 and the lower rigid structure 150.

When the lamp shade 100 is cylindrical in shape, the upper rigid structure 110 is in the form of an upper ring and the lower rigid structure 150 is in the form of a lower ring. The upper rigid structure 110 and the lower rigid structure 150 are thus both continuous structures. It will be appreciated that the upper ring 110 has a first periphery (e.g., a first diameter) and the lower ring 150 has a second periphery (e.g., a second diameter), with the first periphery being less than the second periphery.

The upper ring 110 includes an upper surface 112 and an opposing lower surface 114 and the lower ring 150 includes an upper surface 152 and an opposing lower surface 154. The upper surface 152 faces the lower surface 114 in the assembled lamp shade 100. The upper ring 110 also preferably includes an inner support structure 250 in the form of a center hub 252. The center hub 252 is attached to the upper ring 110 by means of a plurality of spokes 255 that extend radially outward from the center hub 252 and attach to the upper ring 110. The center hub 252 can be a disk-shaped member with a center opening or bore 254 formed therein for receiving mounting hardware that is often associated with a socket and base of a lamp.

The upper ring 110 and lower ring 150 can be formed of any number of different, including but not limited to metal. In the illustrated embodiment, the upper ring 110 and the lower ring 150 comprise round metal wire-like structures. It will be appreciated that the rings 110, 150 do not have to have round (circular) shapes but instead, the rings 110, 150 can have one or more flat surface.

The upper ring 110 includes a plurality of first (top) clips 300 that extend outwardly therefrom. In particular, the first clips 300 extend outwardly (downwardly) from the lower surface 114 and define a clip opening 310 that receives a portion of one frame member 200 for coupling the frame member 200 to the upper ring 110.

In one embodiment, each top clip 300 has a C-shape and is defined by a pair of spaced legs 320 that extend radially outward from the top clip 300. The opening 310 is defined between the legs 320. In one embodiment, a portion of the upper ring 110 that is between the two legs 320 represents a base of the clip 300. In other words, the legs 320 are integrally formed within the upper ring 110 as a part thereof.

Alternatively, as shown in the figures (e.g., FIG. 6), the top clip 300 includes a base portion 330 that extends between the legs 320 and defines in part the opening 310. In other words, the top clip 300 can be a separate structure (C-shaped or U-shaped) that is attached to the lower surface 114 of the upper ring 110 so that the legs 320 extend downwardly therefrom as illustrated. Any number of different types of bonding or attachment techniques can be used to attach the top clip 300 to the upper ring 110. For example, the top clip 300 can be welded to the upper ring 110 when both the clip 300 and the upper ring 110 are formed of metal.

The clip 300 can be formed and positioned so that the opening 310 not only is oriented downwardly but is also oriented outwardly as best shown in FIG. 6. As shown in FIG. 6, the top clip 300 can be attached to the upper ring 110 such that one leg 320 is attached to the upper ring 110 generally at or near a union of the base portion 330 and the one leg 320 with the one leg 320 extending outwardly and beyond the first periphery of the upper ring 110. The other leg 320 extends inwardly relative to the upper ring 110 and is within the first periphery and is free of direct attachment to the upper ring 110. However, as mentioned above, the clip opening 310 is oriented so that is faces slightly outwardly from the upper ring 110.

In the illustrated embodiment, there is one top clip 300 for each frame member 200. When the upper ring 110 includes the support structure 250, the top clips 300 are spaced from and offset from the spokes 255. The illustrated embodiment includes three top clips 300 that can be uniformly spaced about the upper ring 110. Each top clip 300 can be disposed centrally between adjacent, spaced spokes 255.

The base portion 330 is complimentary to the shape of the frame member 200 and thus can be a rounded surface to accommodate a round frame member 200.

The lower ring 150 can have a similar construction to the upper ring 110. In particular, the lower ring 150 can have a plurality of second (bottom) clips 400 that extend outwardly therefrom. In particular, the second clips 400 extend outwardly (downwardly) from the upper surface 152 and define a clip opening 410 that receives a portion of one frame member 200 for coupling the frame member 200 to the lower ring 150.

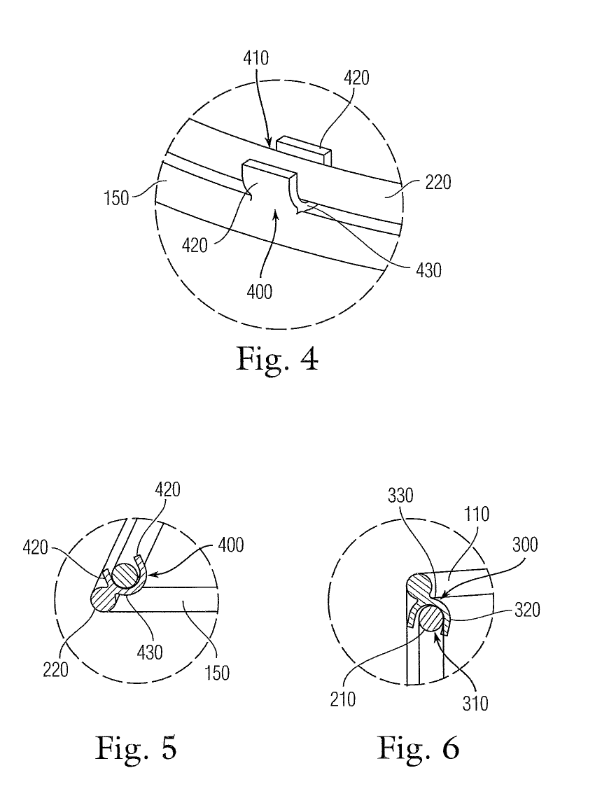

In one embodiment (FIGS. 4 and 5), each bottom clip 400 has a C-shape and is defined by a pair of spaced legs 420 that extend radially outward from the bottom clip 400. The opening 410 is defined between the legs 420. In one embodiment, a portion of the bottom ring 150 that is between the two legs 420 represents a base of the clip 400. In other words, the legs 420 are integrally formed within the lower ring 150 as a part thereof.

Alternatively, as shown in the figures, the bottom clip 400 includes a base portion 430 that extends between the legs 420 and defines in part the opening 410. In other words, the bottom clip 400 can be a separate structure (C-shaped or U-shaped) that is attached to the upper surface 152 of the lower ring 150 so that the legs 420 extend downwardly therefrom as illustrated. Any number of different types of bonding or attachment techniques can be used to attach the bottom clip 400 to the bottom ring 150. For example, the bottom clip 400 can be welded to the lower ring 150 when both the clip 400 and the lower ring 150 are formed of metal.

FIG. 4 shows a separate bottom clip 400 coupled to the lower ring 150.

The clip 400 can be formed and positioned so that the opening 410 not only is oriented upwardly but is also oriented outwardly as best shown in FIG. 5. As shown in FIG. 5, the bottom clip 400 can be attached to the lower ring 150 such that one leg 420 is attached to the lower ring 150 generally at or near a union of the base portion 430 and the one leg 420 with the one leg 420 extending outwardly but within the second periphery of the lower ring 150. The other leg 320 is disposed inwardly relative to the lower ring 150 and is within the first periphery and is free of direct attachment to the lower ring 150. However, as mentioned above, the clip opening 410 is oriented so that is faces slightly outwardly from the lower ring 150.

In the illustrated embodiment, there is a pair of bottom clips 400 for each frame member 200. The illustrated embodiment includes three pairs of bottom clips 400 that can be uniformly spaced about the lower ring 150.

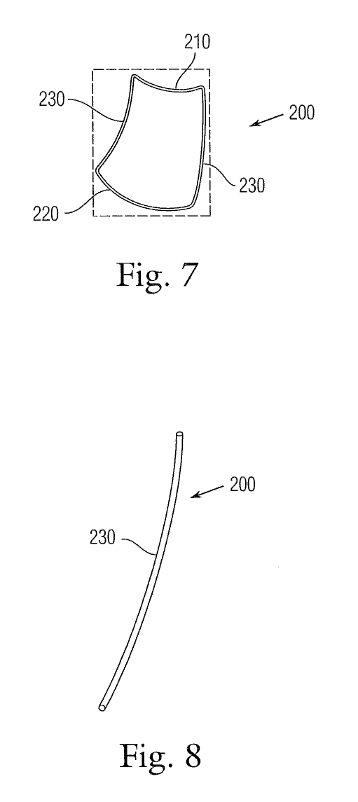

FIGS. 1 and 7 show an exemplary frame member 200 that is coupled to and between the upper ring 110 and the lower ring 150 using the top and bottom clips 300, 400, as described herein. The frame member 200 includes an upper segment 210 and a spaced lower segment 220 and a pair of arms 230 that extend between the upper segment 210 and the lower segment 220. The upper segment 210 extends between the arms 230 and has at least a portion sized to be seatable in one of the top clips 300. In other words, this portion is sized and shaped to be received into and securely captured within the clip opening 310. Similarly, the lower segment 220 extends between the arms 230 and has at least a portion sized to be seatable in one of the bottom clips 400. In other words, this portion is sized and shaped to be received into and securely captured within the clip opening 410.

The lengths of the arms 230 of each frame member 200 is just sufficient to tautly extend the shade material (e.g., fabric material) between the upper ring 110 and the lower ring 150 when the upper and lower segments 210, 220, respectively, are seated in respective top and bottom clips 300, 400.

In the illustrated embodiment, there are three sets of bottom clips 400. The pairs of bottom clips 400 can be uniformly disposed about the periphery of the lower ring 150. Each set of bottom clips 400 is designed to engage and capture the lower segment 220 and therefore, the pair of bottom clips 400 are spaced apart a distance that is less than the length of the lower segment 220.

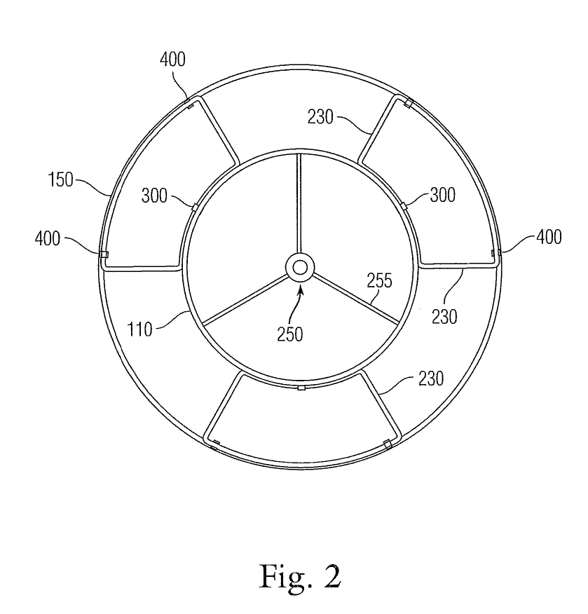

As shown in FIGS. 1 and 7, the upper segment 210, lower segment 220 and the arms 230 have arcuate shapes so as complement the arcuate nature of the rings 110, 150. Since the upper segment 210 mates with the upper ring 110 and the lower segment 220 mates with the lower ring 150, the length of the upper segment 210 is greater than a length of the lower segment 220. Similarly and as best shown in FIG. 2, the single top clip 300 is disposed between the two bottom clips 400 to permit the upper segment 210 and the lower segment 220 to be captured by the respective rings 110, 150.

As shown in FIG. 8, the arcuate nature of the arms 230 of the frame member 200 cause the upper segment 210 to be more inwardly located relative to the lower segment 220 which is necessary due to the smaller diameter of the upper ring 110.

The assembly of the lamp shade 100 is now described. To assemble the lamp shade 100, the upper ring 110 and lower ring 150 and frame members 200 are assembled to form the structure shown in FIG. 1. To couple the frame members 200 to the rings 110, 150, a respective end (segment) of the frame member 200 is mated to a respective clip 300, 400 and the opposite end (segment) of the frame member 200 is mated to the other respective clip 300, 400. For example, the lower segment 220 of one frame member 200 can be coupled to the lower ring 150 by inserting the lower segment 220 into the clip openings 410 of two bottom clips 400. The lower segment 220 is thus captured within the clip openings 410. For example, the lower segment 220 can be frictionally held within the openings 410 of the bottom clips 400. The upper segment 210 is then mated to the upper ring 110 by inserting the upper segment 210 into the clip opening 310 of the top clip 300. The upper segment 210 can be frictionally held within the opening 310 of the top clip 300. When a frictional fit is formed, the width (diameter) of the segments 210, 220 is slightly less than a width of the corresponding opening 310, 410.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A collapsible lamp shade comprising:
(a) a bottom ring having a first periphery;
(b) three pairs of bottom clips affixed to the bottom ring,
wherein each bottom clip has respective legs extending from a central base so as to define a c-shaped receptacle having an opening,
wherein the opening of the bottom clip is oriented both upwardly and outwardly,
wherein one of the legs of each bottom clip is affixed within the first periphery of the bottom ring at a union of the base and one leg thereof,
wherein the other leg of each bottom clip extends inwardly and is free of attachment to the bottom ring, and
wherein each pairs of bottom clips affixed to the bottom ring is substantially uniformly spaced from the other pairs of bottom clips that are affixed to the bottom ring;
(c) a top ring having a second periphery that is smaller than the first periphery;
(d) three top clips affixed to the top ring,
wherein each top clip has respective legs extending from a central base so as to define a c-shaped receptacle having an opening,
wherein the opening of the top-clip is oriented both downwardly and outwardly,
wherein one of the legs of each top clip is affixed within the second periphery of the top ring at a union of the base and one leg thereof,
wherein the other leg of each top clip extends inwardly and is free of attachment to the top ring, and
wherein the top clips are substantially uniformly spaced from one another along the top ring;
(e) a fabric shade attached to the top and bottom rings;
(f) three frame members each having a lower segment, an upper segment and first and second arms each having a length extending therebetween,
wherein the lower segment of each frame member extends between the first and second arms and has at least a portion sized to be seatable in one pair of the bottom clips,
wherein the upper segment of each frame member extends between the first and second arms and has at least a portion sized to be seatable in one of the top clips, and
wherein the length of the first and second arms of each frame member is just sufficient to tautly extend the fabric shade between the bottom and top rings when the lower and upper segments are seated in respective bottom and top clips.

2. The collapsible lamp shade of claim 1, wherein the lower segment of each frame member comprises an arc having a radius that substantially matches that of the bottom ring, and wherein the upper segment comprises an arc having a radius that substantially matches that of the top ring.

3. The collapsible lamp shade of claim 2, wherein the first and second arms extending upwardly and inwardly from the lower segment to the upper segment.

4. The collapsible lamp shade of claim 3, wherein the first and second arms of each frame member each have an attachment to the lower segment and to the upper segment and wherein the attachments to the lower segment are spaced further from one another than the attachments to the upper segment.

5. The collapsible lamp shade of claim 1, further comprising a collapsed state in which the frame members are unseated and an expanded state in which each frame member is seated in respective bottom and top clips, wherein the bottom and top clips are connected inwardly of the first and second peripheries and wherein the legs of the top and bottom clips are sized to be free of contact with the lamp shade when in the expanded state.

6. The collapsible lamp shade of claim 1, wherein the lower segment of each frame member seats between the respective legs of one pair of the bottom clips free of contact with the bottom ring, and wherein the upper segment of each frame member seats between the respective legs of one of the top clips free of contact with the top ring.

7. A collapsible lamp shade frame for receiving a lamp shade material, comprising:
a rigid upper continuous support structure having a first periphery;
a plurality of top clips spaced about and depending from the rigid upper support structure, each top clip having a pair of legs with an opening defined therebetween;
a rigid lower continuous support structure having a second periphery, wherein the second periphery is greater than the first periphery;
a plurality of bottom clips spaced about and depending from the rigid lower support structure, each bottom clip having a pair of legs defining an opening that faces upwardly toward. the rigid upper support structure, the top clips facing downwardly toward the rigid lower support structure; and
a plurality of frame members, each frame member having a top segment, a bottom segment and a pair of arms connected to and extending between the top segment and the bottom segment, wherein the top segment of one frame member is received and securely captured within one top clip and the bottom segment of the one frame member is received and securely captured within a pair of spaced apart bottom clips.

8. The collapsible lamp shade of claim 7, where each of the top and bottom clips has a C-shape with a connector segment between the pair of legs, the respective top and bottom segments being frictionally held within the clip.

9. The collapsible lamp shade of claim 8, wherein the top clip is attached to the rigid upper support structure along one leg of the top clip, with the other leg being free of attachment to the rigid upper support structure, wherein the bottom clip is attached to the rigid lower support structure along one leg of the bottom clip, with the other leg being free of attachment to the rigid lower support structure.

10. The collapsible lamp shade of claim 7, wherein the top clips and the bottom clips are separate elements relative to the rigid upper support structure and the rigid lower support structure and are bonded thereto.

11. The collapsible lamp shade of claim 7, wherein the top segment and the bottom segment have a circular cross-section.

12. The collapsible lamp shade of claim 7, wherein the rigid upper support structure comprises an upper ring and the rigid lower support structure comprises a lower ring that has a diameter less than a diameter of the upper ring.
